(19) United States
(12) Patent Application Publication
(10) Pub. No.: US 2024/0375053 A1
(43) Pub. Date: Nov. 14, 2024

(54) PRESSURE RETARDED OSMOSIS MODULE

(71) Applicant: SALTPOWER HOLDING APS, Sønderborg (DK)

(72) Inventors: Lars Storm PEDERSEN, Sønderborg (DK); Jhony Quintal NUNES, Sønderborg (DK)

(73) Assignee: SALTPOWER HOLDING APS, Sønderborg (DK)

(21) Appl. No.: 18/690,080

(22) PCT Filed: Sep. 9, 2022
(86) PCT No.: PCT/EP2022/075134

§ 371 Date: Mar. 7, 2024

(30) Foreign Application Priority Data
Sep. 10, 2021 (GB) 2112964.8

(51) Int. Cl. B01D 63/02; B01D 61/00; F03G 7/00

(52) U.S. Cl. CPC B01D 63/02; B01D 61/0022; B01D 61/0023; F03G 7/015; B01D 2313/08

(57) ABSTRACT

An osmosis module for pressure retarded osmosis comprising a pressure vessel having a first draw port and a second draw port. The first draw port is provided in a first end-face of the pressure vessel and is in fluid communication with a central structure. A plurality of hollow fibre semipermeable membranes are received within a fibre region of the osmosis module, and are provided around the central structure. In a first lengthwise region of the osmosis module, the draw stream flow between the first draw port and the fibre region via the central structure. In a second lengthwise region of the osmosis module, the flow path which the draw stream flows between the draw ports, is confined to the fibre region and extends substantially parallel to the central structure. The second region extends along a majority of the length of the fibre region.

### CROSS-REFERENCE TO RELATED APPLICATIONS

The present application is a U.S. National Stage Application of International Application No. PCT/EP2022/075134 filed Sep. 9, 2022 and published on Mar. 16, 2023 as WO2023/036944 A1, which claims benefit and priority of Great Britain Patent Application No. GB2112964.8 filed on Sep. 10, 2021, each of which is incorporated herein by reference in its entirety for any purpose whatsoever.

### FIELD OF THE DISCLOSURE

The present disclosure concerns an osmosis module for pressure retarded osmosis. In particular, the present disclosure concerns a hollow fibre osmosis module. The present disclosure also concerns a pressure retarded osmosis system and a method of performing pressure retarded osmosis. The present disclosure also concerns a method of modifying an osmosis module.

### BACKGROUND OF THE DISCLOSURE

Pressure retarded osmosis (PRO) is a process by which a difference in osmotic pressure between two solutions can be used to generate power (e.g. electrical power). A semipermeable membrane is used to separate a less concentrated solution (a feed solution) from a more concentrated solution (a draw solution). Typically, in pressure retarded osmosis the solute is salt and the solvent is water. The membrane allows solvent to pass from the less concentrated solution (with lower osmotic pressure) to the more concentrated solution (with higher osmotic pressure) by osmosis. The solvent that passes through the membrane is sometimes referred to as permeate.

The fluid pressure is allowed to increase on the side of the membrane to which the solvent diffuses. The draw flow therefore has to be pressurized. The permeate is transported from the low pressure side to the high pressure side through the membrane due to the difference in osmotic pressure. This transport of permeate to the draw side can be harnessed to generate electricity; for example by passing the draw flow through a turbine. The gross energy derivable from the process is the product of the volume of permeate and the applied pressure on the high concentration side of the membrane.

$${E}_{gross} = {V}_{permeate} \cdot {P}_{applied}$$

It may therefore be beneficial to operate the process at the highest possible pressure in order to maximize energy generation. In practice, however, the optimum applied pressure will depend on the equipment used.

FIG. 1 shows a first prior art osmosis module 1. The osmosis module 1 comprises a cylindrical housing 2 comprising a first end-face 3, a second end-face 4, and a surrounding wall 5. The housing 2 encloses a plurality of hollow fibres 6 formed of a semipermeable membrane.

At the first end-face 3 is a feed inlet 7, and at the second end-face 4 is a feed outlet 8. The feed inlet 7 and feed outlet 8 are in fluid communication with the interior of the hollow fibres 6. At opposite ends of the surrounding wall 5 are a draw inlet 9 and a draw outlet 10. The draw inlet 9 and draw outlet 10 are in fluid communication with the volume surrounding the outside of the hollow fibres 6.

In use, a low concentration solution is passed into the feed inlet 7 and travels through the hollow fibres 6. At the same time, a high concentration solution is passed into the draw inlet 9 and flows around the outside of the hollow fibres 6. The membrane material allows solvent to pass from the low concentration solution to the high concentration solution by osmosis while preventing the passage of the solute.

Osmosis modules of the type shown in FIG. 1 are typically used in low pressure applications, for example filtration applications, where pressures may be less than 10 bar. In contrast, PRO involves pressures of up to 200 bar. The presence of the both the draw inlet and draw outlet ports in the surrounding wall inherently weakens the structure of the housing which may make osmosis units designed for low pressure applications structurally unsuitable for PRO.

FIG. 2 shows a second prior art osmosis module 11. The osmosis module 11 also comprises a cylindrical housing 12 comprising a first end-face 13, a second end-face 14, and a surrounding wall 15. The housing 12 encloses a plurality of hollow fibres 16 formed of a semipermeable membrane. At the first end-face 13 is a feed inlet 17, and at the second end-face 14 is a feed outlet 18. The feed inlet 17 and feed outlet 18 are in fluid communication with the interior of the hollow fibres 16 of the semipermeable membrane.

A draw inlet 19 of the osmosis module 11 is at the centre of the first end-face 13. The draw inlet 19 is connected to a pipe 21 which extends into, and along the longitudinal axis of, the housing 12. The pipe 21 is therefore surrounded by the hollow fibres 16 of the semipermeable membrane. Inlet holes 22 are distributed along the length of the pipe 21. In use, the high concentration solution is passed into the draw inlet 19, enters the interior of the housing 12 via the inlet holes 22, and exits via draw outlet 20 provided in the surrounding wall 5 proximate the second end-face 14. At the same time, the low concentration solution is passed into the feed inlet 17 and travels through the hollow fibres 16. The membrane material allows solvent to pass from the low concentration solution to the high concentration solution by osmosis while preventing the passage of the solute.

As a result of the central location of the pipe 21, the high concentration solution tends to flow away from the centre of the housing 12 in a radial direction and past the hollow fibres 16 in a crosswise direction. This type of flow may therefore be referred to as a radial flow or cross-flow. When the high concentration solution reaches the surface of the housing 12, it travels from there to the draw outlet 20. In such an arrangement, more solvent transfer tends to occur across the inner fibres than the outer fibres, and the concentration difference between the high and low concentration streams reduces with increasing radial distance. This may lead to inefficiencies in the osmosis process. For example, energy is being expended passing the low concentration stream through the outer fibres, even though less solvent transfer is occurring across those fibres. In addition, the inner fibres may become clogged with scale more quickly than the outer fibres, and therefore the inner fibres may reach the end of their operational life faster than the outer fibres or cleaning may be needed more often.

The present disclosure seeks to mitigate the above-mentioned problems. Alternatively or additionally, the present disclosure seeks to provide an improved osmosis module for pressure retarded osmosis. Alternatively or additionally, the present disclosure seeks to provide an improved pressure retarded osmosis system.

### SUMMARY OF THE DISCLOSURE

The present disclosure provides, according to a first aspect, an osmosis module for pressure retarded osmosis. The osmosis module comprises a pressure vessel comprising: a first end-face, a second end-face, a surrounding wall extending between the first end-face and the second end-face, and a pair of draw ports via which a draw stream can flow into and out of an interior of the pressure vessel. The pair of draw ports comprise a first draw port and a second draw port. The osmosis module further comprises a plurality of hollow fibre semipermeable membranes received within the interior of the pressure vessel. The plurality of hollow fibre semipermeable membranes are provided around a central structure. The plurality of hollow fibre semipermeable membranes are located within a fibre region which radially extends between the central structure and the surrounding wall. The fibre region has a length in a direction parallel to the longitudinal axis of the pressure vessel. The first draw port is provided in the first end-face, and the central structure is in fluid communication with the first draw port. The osmosis module comprises a first region extending along a first lengthwise portion of the fibre region, and a second region extending along a second lengthwise portion of the fibre region. In the first region the draw stream can flow between the first draw port and the fibre region via the central structure. In the second region the flow path, via which the draw stream flows between the draw ports, is confined to the fibre region and extends substantially parallel to the central structure.

Thus, it may be that draw fluid flowing between the draw ports must flow lengthwise through the fibre region (rather than radially or through the central structure) along a substantial portion of the length of the module. Providing an osmosis module having a lengthwise region (the second region) in which the draw stream flow is confined to the fibre region, and wherein the direction of flow is parallel to the central structure (rather than in a radial direction), may reduce the extent to which a concentration gradient is established in the radial direction in the draw stream solution. This may cause the solvent transfer to be more evenly distributed across all of the hollow fibre semipermeable membranes, which in turn may allow a more energy efficient osmosis process. Additionally or alternatively, such an arrangement may mean that the inlet ends (e.g. the end via which the feed stream enters the fibre) of more hollow fibre semipermeable membranes are exposed to a higher concentration draw stream, thereby prompting more transfer across the membrane in the region of the inlet end and reducing pressure loss in the feed stream as it travels through the fibre. The present disclosure may allow a higher overall recovery of the feed, resulting in an improved energy efficiency and energy output.

It will be appreciated that the first region and the second region are separate regions distributed along the length (i.e. longitudinal axis) of the osmosis module. It will be appreciated that the regions do not overlap. The regions may be spaced apart, i.e. separated by a gap, or they may be touching.

The draw stream may be a high (i.e. higher) concentration stream. The feed stream may be a low (i.e. lower) concentration stream.

It may be that in the first region, the interior of the central structure and the fibre region are in fluid communication. It may be that in the second region, the interior of the central structure and the fibre region are not in fluid communication.

The central structure may comprise one or more apertures via which the interior of the central structure and the fibre region are in fluid communication. In use, the draw stream may flow into or out of the fibre region via the one or more apertures. In the first region, the central structure may comprise said apertures (such that the central structure and the fibre region are in fluid communication). In the second region, the central structure may be free of said apertures (such that the central structure and the fibre region are not in fluid communication).

In the first region, the central structure may be configured to allow fluid to flow therewithin. In the second region, the central structure may be configured to prevent fluid flowing therewithin. For example, the central structure may comprise a first internal wall preventing fluid flow along the whole length of the central structure. The first internal wall may define one end of the first region. A first end of the second region may be aligned, in the lengthwise direction, with the first internal wall. Thus, the first region may end and the second region may begin at the lengthwise position of the first internal wall.

The central structure may be configured to deliver (or receive) the entire high concentration stream to (or from) the fibre region within the first region.

The first region may extend along a minor portion of the length of the fibre region, said portion being less than the majority of the length. The first region may extend for no more than 50%, for example no more than 25%, for example no more than 10% of the way along the length of the fibre region (measured from the end of the fibre region closest to the first end-face of the pressure vessel). The second region may extend for more than 40% of the length of the fibre region, for example more than 50% of the length of the fibre region (i.e. the second region may extend along a majority of the length of the fibre region), for example more than 75% of the length of the fibre region, for example more than 90% of the length of the fibre region.

The central structure may comprise a first duct in fluid communication with the first draw port. The first duct may allow fluid to flow therewithin. The first duct may extend along the length of the first region. The first duct may extend only a part of the way along length of the fibre region.

A first portion of the flow path may be provided by the first duct. That is to say, for said first portion fluid may flow through the first duct. The first duct may provide the first portion of the flow path no further than (i.e. only) a part of the way along the length of the fibre region. In other words, the first portion of the flow path may be provided to, at the furthest, a position only a part of the way along the length of the fibre region.

The first duct may have a length from a proximal end at the first draw port, to a distal end. The first portion of the flow path may be provided from the proximal to the distal end, at the most. The distal end may be defined by the first internal wall in the central structure.

The osmosis module may be configured such that, along a majority of the flow path in the fibre region, the net flow of the draw stream is in a direction substantially parallel to the central structure. It may be the entire draw stream passes through the fibre region in the second region. The entire draw stream may have (and in use follow) the aforementioned flow path. A second portion of the flow path may be through the fibre region. In the second region, the flow path may comprise an annular cross-sectional shape.

It will be appreciated that as used herein, the term flow path refers to a volume through which a stream, for example the draw stream, can pass. Likewise, “the flow path via which the draw stream flows between the draw ports” as used herein may refer to the volume through which the draw stream can pass between the draw ports.

It will be appreciated that as used herein, the term “second region” refers to a lengthwise region in which the flow path, via which the draw stream flows between the draw ports, is confined to the fibre region and extends substantially parallel to the central structure. That is to say, in the second region, the draw stream flows in a direction substantially parallel to the longitudinal axis of the central structure along the whole of the length of the second region. Thus, when the second region extends along a majority of the length of the fibre region, the draw stream flows in a direction substantially parallel to the longitudinal axis of the central structure along a majority of the length of the fibre region.

It may be that there are regions of the osmotic module which are in fluid communication with the flow path, but through which fluid cannot flow to the draw ports (e.g. dead ends)—such regions do not form part of a volume through which the draw stream can flow between the draw ports and are therefore not on the flow path via which the draw stream flows between the draw ports.

The second draw port may be provided in the surrounding wall. The second draw port may be provided in the surrounding wall at a position proximate (e.g. adjacent) to the second end-face. The second draw port may be provided no more than 30%, for example no more than 20%, for example no more than 10% of the way along the length of the fibre region (measured from the end of the fibre region closest to the second end-face of the pressure vessel). There may be no overlap, in the longitudinal direction, between the second draw port and the first region (or the first portion of the flow path, or the first duct).

The second draw port may be provided in the second end-face of the pressure vessel. Both the draw ports may thus be provided in respective end faces of the pressure vessel. This may reduce the number of ports in the surrounding wall and thus improve the strength of the surrounding wall. This may allow the pressure vessel to withstand a higher operating pressure without the need to reinforce the wall, for example by making it thicker or by making it out of stronger materials or by providing additional structure around the draw ports.

The osmosis module may comprise a third region extending along a third lengthwise portion of the fibre region. In the third region, the draw stream may be able to flow between the second draw port and the fibre region via the central structure.

It will be appreciated that the first region, the second region, and the third region are separate regions distributed along the length (i.e. longitudinal axis) of the osmosis module. It will be appreciated that the regions do not overlap. The first region, second region and third region may be distributed along the length of the osmosis module in that order. Adjacent regions may be spaced apart, i.e. separated by a gap, or they may be touching.

It may be that in the third region, the central structure and the fibre region are in fluid communication. In the third region, the central structure may comprise said apertures, via which the central structure and the fibre region are in fluid communication (such that the central structure and the fibre region are in fluid communication).

In the third region, the central structure may be configured to allow fluid to flow therewithin. The central structure may comprise a second internal wall preventing fluid flow along the whole length of the central structure. A second end of the second region may be aligned, in the lengthwise direction, with the second internal wall. The second internal wall may define one end of the third region. Thus, the second region may end and the third region may begin at the lengthwise position of the second internal wall.

The central structure may be configured to deliver (or receive) the entire high concentration stream to (or from) the fibre region within the third region.

The third region may extend for no more than 50%, for example no more than 25%, for example no more than 10% of the way along the length of the fibre region (measured from the end of the fibre region closest to the second end-face of the pressure vessel).

The central structure may comprise a second duct in fluid communication with the second draw port. The second duct may allow fluid to flow therewithin. The second duct may extend along the length of the third region. The second duct may extend only a part of the way along the length of the fibre region.

A third portion of the flow path may be provided by (i.e. is through) the second duct. The second duct may provide the third portion of the flow path no further than (i.e. only) a part of the way along the length of the fibre region. In other words, the third portion of the flow path may be provided to, at the furthest, a position only a part of the way along the length of the fibre region.

The second duct may have a length from a proximal end at the second draw port, to a distal end. The third portion of the flow path may be provided from the proximal to the distal end, at the most. The distal end may be defined by the second internal wall in the central structure.

The central structure may receive a blocking member, for example a plug or bung. The blocking member may provide the first and/or second internal wall of the central structure. The central structure may comprise a duct structure. The duct structure may extend along a majority of the length of the pressure vessel. The duct structure may extend from the first end-face to the second end-face.

The duct structure may be blocked (with the blocking member) part-way along its length so as to form the first duct, a blocked region, and optionally also the second duct. The duct structure may provide the first duct (and thus the first portion of the flow path) on one side of the blocked region, and the second duct (and thus the third portion of the flow path) on the other side of the blocked region. The central structure may be blocked such that fluid can travel no further than 50%, 40%, 30%, 20%, or 10% of the way along the fibre region from either end of the pressure vessel.

The duct structure may be in the form of a hollow elongate member. The duct structure may be in the form of a pipe. The first duct and/or second duct may comprise a plurality of flow channels. The first duct and/or second duct may be subdivided into a plurality of individual flow channels. The first duct and/or second duct may be bifurcated, and the plurality of flow channels may each have separate outer walls (whilst still forming a central structure).

The pressure vessel may comprise a first end-cap providing the first end-face. The pressure vessel may comprise a second end-cap providing the second end-face. The first end-cap and the second end-cap may have substantially identical geometry (e.g. identical geometry). This may reduce the number of different parts that need to be produced when manufacturing the osmotic module. At least one of, optionally both of, the end-caps may be removable. This may allow the semipermeable membrane to be removed from the pressure vessel and replaced.

The pressure vessel may further comprise a pair of feed ports for passage of a feed stream into and out of the interior of the pressure vessel. The pair of feed ports may comprise a first feed port and a second feed port. The feed ports may be in fluid communication with the interior of the hollow fibre semipermeable membranes. The first feed port may be provided in the first end-face. The second feed port may be provided in the second end-face. The osmosis module may be arranged to provide a flow path via which the feed stream flows between the feed ports. The flow path may be through the interior of the hollow fibre semipermeable membranes.

The surrounding wall of the pressure vessel may be free of ports for passage of fluid into and out of the interior of the pressure vessel. For example, the surrounding wall of the pressure vessel may have no draw ports and no feed ports.

The osmosis module may comprise an exterior wrap or shell around the plurality of hollow fibre semipermeable membranes, for example substantially all of the hollow fibre semipermeable membranes. The wrap may comprise a length of material, for example felt, wrapped around the plurality of hollow fibre semipermeable membranes. The shell may comprise a plurality of parts, for example two semi-cylindrical parts, which together surround the plurality of hollow fibre semipermeable membranes. The wrap or shell may reduce the extent to which the draw stream is able to bypass the plurality of hollow fibre semipermeable membranes, for example by flowing along the inner surface of the surrounding wall, rather than through the interior of the fibre region. The wrap or shell may force the draw stream to flow through the interior of the fibre region. The wrap or shell may be formed of a permeable material. Despite the permeability of the material, the wrap or shell may have sufficiently high flow resistance to force most of the draw stream to flow through the interior of the fibre region.

A region of the surrounding wall may have a smaller inner diameter than end regions of the surrounding wall. For example, the inner diameter in said region may be more than 1%, for example more than 5%, for example more than 10% smaller than the inner diameter at the end regions. Said region of the surrounding wall may contact the plurality of hollow fibre semipermeable membranes. Said region of the surrounding wall may limit any gap that would otherwise exist between the outer hollow fibre semipermeable membranes and the inner surface of the surrounding wall. Said region of the surrounding wall may thereby reduce the extent to which the high concentration solution is able to bypass the plurality of hollow fibre semipermeable membranes, for example by flowing along the inner surface of the surrounding wall, rather than through the interior of the fibre region. Said region of the surrounding wall may force the draw stream to flow through the interior of the fibre region.

The end regions of the surrounding wall may form a funnel shape, for example having a larger diameter at an outer end and a smaller diameter at an inner end. This may allow the hollow fibre semipermeable membranes to be more easily inserted into the pressure vessel.

The pressure vessel may be capable of withstanding an operating pressure of at least 50 Bar, for example at least 100 Bar, for example at least 150 Bar, for example at least 200 Bar.

There may be a first surface of the hollow fibre semipermeable membranes, the first surface being outside of the hollow fibre semipermeable membranes. There may be a second surface of the hollow fibre semipermeable membranes, the second surface being inside of the hollow fibre semipermeable membranes. The draw ports may be in fluid communication with the first surface of the hollow fibre semipermeable membranes. The feed ports may be in fluid communication with the second surface of the hollow fibre semipermeable membranes.

The first draw port may be a draw inlet, and the second draw port may be a draw outlet. Alternatively, the first draw port may be a draw outlet, and the second draw port may be a draw inlet. The draw inlet may be configured to allow passage of the draw stream into the pressure vessel and to the first surface of the hollow fibre semipermeable membranes. The draw outlet may be configured to allow passage of a reduced concentration stream out of the interior of the pressure vessel, the reduced concentration output stream being derived from the draw stream (after having flowed past the first side of the membranes).

The first feed port may be a feed inlet, and the second feed port may be a feed outlet. Alternatively, the first feed port may be a feed outlet, and the second feed port may be a feed inlet. The feed inlet may be configured to allow passage of a feed stream into the interior of the pressure vessel and to the second surface of the hollow fibre semipermeable membranes. The feed outlet may be configured to allow passage of an increased concentration stream out of the interior of the pressure vessel, the increased concentration stream being derived from the feed stream (after having flowed past the second side of the membranes).

The pressure vessel may have a generally cylindrical shape (e.g. a cylindrical shape). The pressure vessel may have a circular cross section, said cross section being taken in a plane perpendicular to a longitudinal axis of the pressure vessel. The first draw port may be provided in the centre of the first end face. The second draw port may be provided in the centre of the second end face.

The central structure may be cylindrical. The central structure may extend parallel to, and optionally along, the longitudinal axis of the pressure vessel. The central structure may extend along substantially the full length of the fibre region. The fibre region and the central structure may be coaxial. In the second region, it may be that the flow path extends substantially parallel to a longitudinal axis of the central structure.

The flow path in the second region may be substantially cylindrical. The flow path in the second region may have a (e.g. circumferential) outer surface where the fibre region meets the inside of the surrounding wall of the pressure vessel or the wrap or shell. The outer surface of the flow path in the second region may have a substantially constant cross section as between the ends of the second region. For example, there may be no lengthwise positions where there are inward projections into the fibre region to substantially distort the flow path. The outer surface of the flow path in the second region may have a constant radius.

The flow path in the second region may have a (e.g. circumferential) inner surface where the fibre region meets the outside of the central structure. The inner surface of the flow path in the second region may have a substantially constant cross section as between the ends of the second region. For example, there may be no lengthwise positions where there are outward projections into the fibre region to substantially distort the flow path. The inner surface of the flow path in the second region may have a constant radius.

The hollow fibre semipermeable membranes may each follow a straight path. The hollow fibre semipermeable membranes may each follow a spiral path. The plurality of hollow fibre semipermeable membranes may be wound around the central structure. The plurality of hollow fibre semipermeable membranes may together (i.e. collectively) form a bundle of hollow fibres. The osmosis module may comprise a manifold arranged to distribute the feed stream to the open ends of the hollow fibre semipermeable membranes. There may be a manifold arranged to receive the increased concentration stream from the (other) open ends of the hollow fibre semipermeable membranes. The plurality of hollow fibre semipermeable membranes may be stuck together at one end or both ends. The plurality of hollow fibre semipermeable membranes may be set in a sealing compound at one or both ends. The central structure may project through the sealing compound.

The fibre region may be an annular fibre region. The annular fibre region may circumferentially surround the central structure. The plurality of hollow fibre semipermeable membranes may collectively define the fibre region. The fibre region may be the notional volume that the plurality of hollow fibre semipermeable membranes (e.g. substantially all of the hollow fibre semipermeable membranes) together (i.e. collectively) occupy within the interior of the pressure vessel, and includes the space between the individual fibres through which the draw stream flows through in use. It may be that said notional volume has a first end and a second end spaced apart along the longitudinal axis of the of the pressure vessel; and the length of the fibre region is the distance between the first end and the second end. The fibre region may extend along the majority of the length of the pressure vessel.

The fibre region may be free of structures such as baffles within the second region. The fibre region (as a whole) may be free of baffles. Baffles are flow diverting structures formed in the fibre region. For example a baffle may comprise an elongate structure extending radially with respect to the central structure from the outer or inner edge of the fibre region. They may, for example, be formed of resinous material. Baffles can restrict the fluid flow though the hollow fibre region. Baffles can also cause the direction of the draw stream through the hollow fibre region to be diverted in a way that promotes cross flow. It may be advantageous to provide a fibre region free of baffles in order to minimise flow resistance of the draw stream through the osmosis module, and/or to allow draw stream flow in a direction parallel to the hollow fibre membranes.

The present disclosure provides, according to a second aspect, a pressure retarded osmosis system. The pressure retarded osmosis system comprises an osmosis module according to the first aspect of the disclosure. The pressure retarded osmosis system is configured to provide a draw stream to one of the draw ports (a draw inlet), and a feed stream to one of the feed ports (a feed inlet).

The pressure retarded osmosis system may comprise one or more pumps for pumping the draw stream and/or feed stream. The pressure retarded osmosis system may be configured to pressurise the draw stream, for example to more than 50 Bar, more than 100 Bar, more than 150 Bar, or more than 200 Bar.

The pressure retarded osmosis system may further be arranged to receive a reduced concentration stream from another of the draw ports (a draw outlet), and receive an increased concentration stream from another feed port (a feed outlet). The pressure retarded osmosis system may comprise a pressure exchanger configured to transfer pressure from the reduced concentration stream to the draw stream.

It may be that, the draw stream flows in a direction from the first end-face to the second end-face, and the feed stream flows in a direction from the second end-face to the first end-face. Such an arrangement may be referred to as a counter-current arrangement. In this case, the draw outlet and feed inlet may be at a first end of the pressure vessel (e.g. at the first end-face), and the draw inlet and feed outlet may be at a second end of the pressure vessel (e.g. at the second end-face).

It may be that, both the draw stream and the feed stream flow in a direction from the first end-face to the second end-face. Such an arrangement may be referred to as a co-current arrangement. In this case, the draw inlet and feed inlet may be at a first end of the pressure vessel (e.g. at the first end-face), and the draw outlet and feed outlet may be at a second end of the pressure vessel (e.g. at the second end-face).

Whether a co-current or counter-current arrangement is preferable may depend on the nature of the feed stream. A co-current arrangement may have advantages where the feed stream has no or negligible salinity. A co-current arrangement may lead to a larger osmotic pressure difference across the semipermeable membranes near the inlet side, as a ‘fresh’ draw solution and a ‘fresh’ feed solution are present either side of the membrane. This may mean the flux of permeate crossing the membrane is higher near the inlet side, and lower near the outlet side. By transferring more solvent from the feed stream to the draw stream earlier on, less energy may be required to supply the feed stream as on average the solvent does not need to be passed as far along the pressure vessel before crossing them membrane. It has been found this may lead to a more efficient pressure retarded osmosis process, for example as compared to a counter-current arrangement under otherwise identical conditions. On the other hand, a counter-current arrangement may have advantages where the feed stream is a saline stream. For example, it may allow a higher minimum pressure differential to be maintained along the length of the pressure vessel.

The osmosis module may be in fluid communication with (and the pressure retarded osmosis system may comprise) a reservoir holding a high concentration solution for use as the draw stream. The osmosis module may be in fluid communication with (and the pressure retarded osmosis system may comprise) a reservoir holding a low concentration solution for use as the feed stream.

The present disclosure provides, according to a third aspect, a power generation system. The power generation system comprises a pressure retarded osmosis system according to the second aspect of the disclosure. The power generation system further comprises a power generation device, for example a turbine. The power generation device may be in fluid communication with the reduced concentration stream. The power generation device may be configured to generate power using the increased pressure of reduced concentration stream (e.g. as compared to the draw stream entering the draw inlet).

The present disclosure provides, according to a fourth aspect, a method of performing pressure retarded osmosis. The method comprises providing a pressure retarded osmosis system according to the second aspect of the disclosure. The method comprises passing a draw stream into one of the draw ports (a draw inlet), and a feed stream into one of the feed ports (a feed inlet). The method may further comprise receiving a reduced concentration stream from another of the draw ports (a draw outlet), and receiving an increased concentration stream from another of the feed ports (a feed outlet). The method may further comprise generating power using a power generation device, for example a turbine.

Suitable draw and feed streams will be known to those skilled in the art. An example of a draw stream is an aqueous saline stream. The salt content of the draw stream may be anything up to saturation. The salt content may be at least 3% wt, optionally at least 5% wt, optionally at least 10% wt, optionally at least 15% wt, and optionally at least 20% wt. It will be appreciated that the draw stream may contain a wide variety of dissolved salts, comprising or with a preponderance of sodium chloride, potassium chloride and/or calcium chloride. “Salt content” refers to total salt content. The exact nature of the salt(s) present in such streams is not important. The draw stream may be obtained from any suitable source; for example, from an industrial process, the direct mixing of a salt and solute, the sea (the draw stream being seawater), or a geothermal formation.

It will be appreciated that the salinity of the feed stream is less than the salinity of the draw stream. An example of a feed stream is an aqueous stream with a negligible salt content. It may be that the salt content of the feed stream is 0 wt %. Alternatively, it may be that the feed stream contains salt(s) provided that the salinity of said stream is less than the salinity of the draw stream. The feed stream may be obtained from any suitable source. The feed stream may be sea water. The feed stream may be fresh or brackish water obtained, for example, from a river or a lake, ground water, or waste water obtained from an industrial or municipal source. The feed stream may be condensate produced during an industrial process.

Alternatively or additionally, the draw stream and feed stream may comprise differing concentrations of organic molecules (e.g. organic compounds) so as to establish a difference in osmotic pressure across the semipermeable membrane. The organic molecules may, for example, comprise sugar, such as glucose. It will be appreciated that the concentration of the organic molecules in the feed stream is less than in the draw stream.

The semipermeable membrane is configured to allow solvent to pass from the draw stream to the feed stream. The semipermeable membrane may permit the passage of water but not the passage of salts.

The present disclosure provides, according to a fifth aspect, a method of modifying an osmosis module. The osmosis module comprises a pressure vessel comprising: a first end-face, a second end-face, a surrounding wall extending between the first end-face and the second end-face, and a pair of draw ports via which a draw stream can flow into and out of an interior of the pressure vessel. The pair of draw ports comprises a first draw port and a second draw port. The osmosis module further comprises a plurality of hollow fibre semipermeable membranes received within the interior of the pressure vessel and provided around a central structure. The plurality of hollow fibre semipermeable membranes being located within a fibre region which extends radially between the central structure and the surrounding wall of the pressure vessel. The fibre region has a length in a direction parallel to the longitudinal axis of the pressure vessel. The first draw port is provided in the first end-face, and the central structure is in fluid communication with the first draw port. The method comprises a step of blocking the central structure part-way along its length such that the osmosis module comprises: a first region extending along a first lengthwise portion of the fibre region, wherein in the first region the draw stream can flow between the first draw port and the fibre region via the central structure, and a second region extending along a second lengthwise portion of the fibre region, wherein in the second region the flow path, via which the draw stream flows between the draw ports, is confined to the fibre region and extends substantially parallel to the central region.

By modifying an osmosis module so as to have a lengthwise region (the second region) in which the draw stream flow is confined to the fibre region, and wherein the direction of flow is parallel to the central structure (rather than in a radial direction), the extent to which a concentration gradient is established in the draw stream solution as between inner and outer regions of the pressure vessel may be reduced. This may cause the solvent transfer to be more evenly distributed across all of the hollow fibre semipermeable membranes, which in turn may improve the energy efficiency of an osmosis process using the osmosis module. Additionally or alternatively, modifying the osmosis module in this way may allow a commercially available osmotic module for lower pressure applications to be reused in higher pressure applications such as pressure retarded osmosis.

The central structure may be blocked by inserting a blocking member, such as a plug or bung, within the central structure.

The second draw port may be provided in the second end-face. The central structure may be in fluid communication with the second draw port. The method may comprise blocking a region of the central structure such that the first region is provided on one side of the blocked region, and there is a third region of the osmosis module on another side of the blocked region, the third region extending along a third lengthwise portion of the fibre region, and in the third region the draw stream can flow between the second draw port and the fibre region via the central structure.

The method may further comprising a step of providing a wrap or shell around the plurality of hollow fibre semipermeable membranes. This may reduce flow of the draw stream along an inner surface of the surrounding wall.

The method may comprise modifying an osmosis module so as to provide an osmosis module according to the first aspect of the disclosure. The modified osmosis module may have any of the features described in relation to the first aspect of the disclosure.

The present disclosure provides, according to a sixth aspect, a pressure retarded osmosis system comprising an osmosis module. The osmosis module comprises a pressure vessel comprising a first end-face, a second end-face, a surrounding wall extending between the first end-face and the second end-face. The osmosis module further comprises a plurality of hollow fibre semipermeable membranes received within an interior of the pressure vessel. The pressure retarded osmosis system is configured such that, in use, both a draw stream and a feed stream flow in a direction from the first end-face to the second end-face. The pressure retarded osmosis system according to the sixth aspect thus has a co-current arrangement.

The osmosis module may comprise a pair of draw ports for passage of a high concentration stream into and out of an interior of the pressure vessel, and a pair of feed ports for passage of a low concentration stream into and out of the interior of the pressure vessel. The pair of draw ports may comprise a first draw port at a first end of the pressure vessel, and a second draw port at a second end of the pressure vessel. The pair of feed ports may comprise a first feed port at the first end of the pressure vessel, and a second feed port at the second end of the pressure vessel.

The pressure retarded osmosis system may be configured to provide a draw stream to the first draw port, and provide a feed stream to the first feed port. The pressure retarded osmosis system may be configured to receive a reduced concentration stream from the second draw port, and an increased concentration stream from the second feed port.

It will of course be appreciated that features described in relation to one aspect of the present disclosure may be incorporated into other aspects of the present disclosure. For example, the method of the disclosure may incorporate any of the features described with reference to the apparatus of the disclosure and vice versa.

### DESCRIPTION OF THE DRAWINGS

Embodiments of the present disclosure will now be described by way of example only with reference to the accompanying schematic drawings of which:

FIG. 1 shows a side view of a first prior art osmosis module;

FIG. 2 shows a side view of a second prior art osmosis module;

FIGS. 3a and 3b show a side view of an osmosis module according to a first embodiment of the disclosure, in a co-current arrangement;

FIG. 4 shows an enlarged side view of a first end of the osmosis module according to a first embodiment of the disclosure;

FIG. 5 shows a side view of an osmosis module according to a first embodiment of the disclosure, in a counter-current arrangement;

FIG. 6 shows a schematic view of a power generation system according to an embodiment of the disclosure;

FIG. 7 shows a side view of an osmosis module according to a second embodiment of the disclosure, in a co-current arrangement;

FIG. 8 shows a side view of an osmosis module according to a second embodiment of the disclosure, in a counter-current arrangement;

FIG. 9 shows a method of modifying an osmosis module according to a third embodiment of the disclosure.

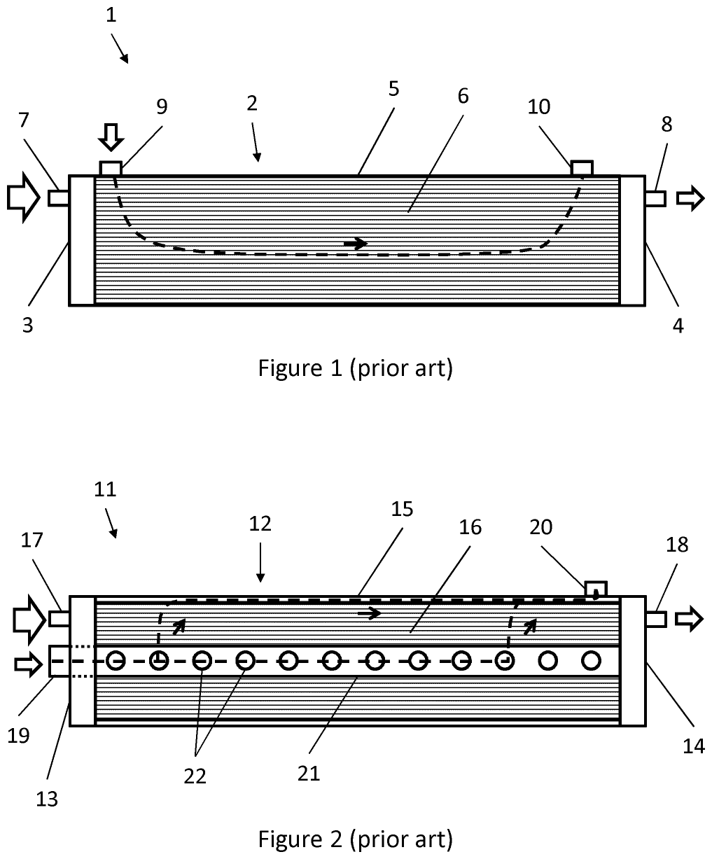

### DETAILED DESCRIPTION

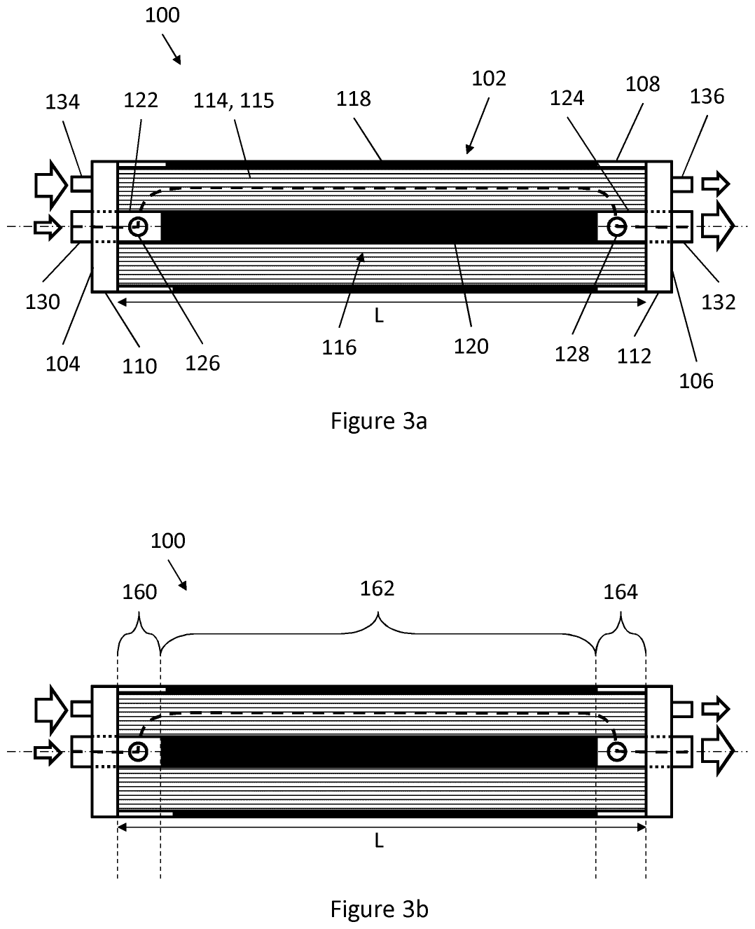

FIG. 3 shows an osmosis module 100 according to a first embodiment of the disclosure. The osmosis module 100 is configured for use in a pressure retarded osmosis system, and is capable of withstanding an operating pressure of at least 100 Bar. The osmosis module 100 comprises a cylindrical pressure vessel 102 comprising a first end-face 104, a second end-face 106, and a surrounding wall 108 extending between the first end-face 104 and the second end-face 106. The pressure vessel 102 has a longitudinal axis (shown as a broken line) running along its length. The first end-face 104 is provided by a first end-cap 110 which closes a first end of the surrounding wall 108, and the second end-face 106 is provided by a second end cap 112 which closes a second end of the surrounding wall 108.

A plurality of hollow fibre semipermeable membranes 114 are located inside the pressure vessel 102. The semipermeable membrane material permits passage of solvent (in this case water) but not of salts. The plurality of hollow fibre semipermeable membranes 114 are provided in an annular arrangement around a cylindrical central structure 116 which is positioned coaxially with the pressure vessel 102. The plurality of hollow fibre semipermeable membranes 114 define an annular fibre region 115 between the central structure 116 and the surrounding wall 108. The annular fibre region 115 extends radially from the central structure 116 to the surrounding wall 108. The annular fibre region 115 has a length L in a direction parallel to the longitudinal axis of the pressure vessel 102. The annular fibre region 115 and the central structure 116 are both coaxial with the pressure vessel 102.

The plurality of hollow fibre semipermeable membranes 114 are collectively wrapped in wrap 118 formed of a length of felt. The wrap 118 extends circumferentially around the plurality of hollow fibre semipermeable membranes 114 and is located between the outermost hollow fibre semi permeable membranes and the surrounding wall 108. In alternative embodiments, the plurality of hollow fibre semipermeable membranes 114 are circumferentially surrounded by a shell comprising two open-ended semi-cylindrical parts.

The central structure 116 is formed of a duct structure in the form of a pipe. A blocking member in the form of a plug 120 blocks a middle region of the central structure 116 so as to define a first duct 122 and a second duct 124 on opposite sides of the middle region. The first duct 122 and the second duct 124 extend only a part of the way along the length L of the annular fibre region 115. In the embodiment shown, the first duct 122 and the second duct 124 extend less than 10% of the way along the length L of the annular fibre region 115.

The first duct 122 comprises an aperture 126 via which the first duct 122 is in fluid communication with the annular fibre region 115. Similarly, the second duct 124 comprises an aperture 128 via which the second duct 124 is in fluid communication with the annular fibre region 115. Specifically, the first duct 122 and second duct 124 are in fluid communication with the volume outside of the hollow fibre semipermeable membranes 114. The apertures 126, 128 are provided at a position radially inward of the annular fibre region 115.

The pressure vessel 102 further comprises a first draw port 130 provided in a centre of the first end-face 104, and a second draw port 132 provided in a centre of the second end-face 106. The first draw port 130 is in fluid communication with the first duct 122, and the second draw port 132 is in fluid communication with the second duct 124. The draw ports 130, 132 are thus in fluid communication with the annular fibre region 115.

The osmosis module 100 provides a flow path for a draw stream between the first draw port 130 and the second draw port 132. An example flow along the flow path is shown as a dashed line. The flow path comprises (i) a first portion which is provided by (i.e. through) the first duct 122, (ii) a second portion which is within the annular fibre region 115 and specifically around the outside of the hollow fibre semipermeable membranes 114, and (iii) a third portion which is provided by the second duct 124.

As the first duct 122 and the second duct 124 extend only a part of the way along the length of the annular fibre region 115, the first duct 122 and the second duct 124 provide the first portion and the third portion, respectively, of the flow path no further than a part of the way along the length of the annular fibre region 115. Along a majority of the second portion of the flow path, the entire draw stream is forced to flow in a direction substantially parallel to the longitudinal axis of the pressure vessel 102. As a result, and in comparison to the osmosis module of FIG. 2 for example, the concentration of the draw stream may vary less in the radial direction, and consequently the fluid transfer across the hollow fibre semipermeable membranes may be more even and less dependent on radial position.

As shown in FIG. 3b, a first lengthwise region 160, a second lengthwise region 162, and a third lengthwise region 164 of the osmosis module 100 can be defined. The first region 160 extends along a first lengthwise portion of the annular fibre region 115. In the first region 160, the draw stream can flow between the first draw port 130 and the annular fibre region 115 via the central structure 116. The first region 160 is thus defined by, and extends along, the length of the first duct 122.

The second region 162 extends along a second lengthwise portion of the annular fibre region 115. The draw stream flow, whilst travelling through the second region 162, is confined to the annular fibre region 115, and the net direction of flow is substantially parallel to the longitudinal axis of the pressure vessel 102. The flow path is thus confined to the annular fibre region 115 and extends substantially parallel to the central structure 116. The draw stream flows in a direction substantially parallel to the longitudinal axis of the central structure 116 along the length of the second region. The second region 162 extends along substantially the length of the plug 120. The ends of the second region 162 are substantially aligned, in the lengthwise direction, with the ends of the plug 120.

The third region 164 extends along a third lengthwise portion of the annular fibre region 115. In the third region 164, the draw stream can flow between the second draw port 132 and the annular fibre region 115 via the central structure 116. The third region 164 is thus defined by, and extends along, the length of the second duct 124.

Furthermore, the wrap 118 reduces the amount of fluid that is able to bypass the hollow fibre semipermeable membranes 114 by flowing along the inner surface of the surrounding wall 108. This may increase the average contact between the draw stream and the hollow fibre semipermeable membranes 114. In alternative embodiments, the wrap 118 is not provided and the hollow fibre semipermeable membranes 114 contact the inner surface of the surrounding wall 108 of the pressure vessel 102. In alternative embodiments, the surrounding wall 108 has a middle section comprising a reduced internal diameter so as to occupy the volume shown in FIG. 3 as being occupied by the wrap 118.

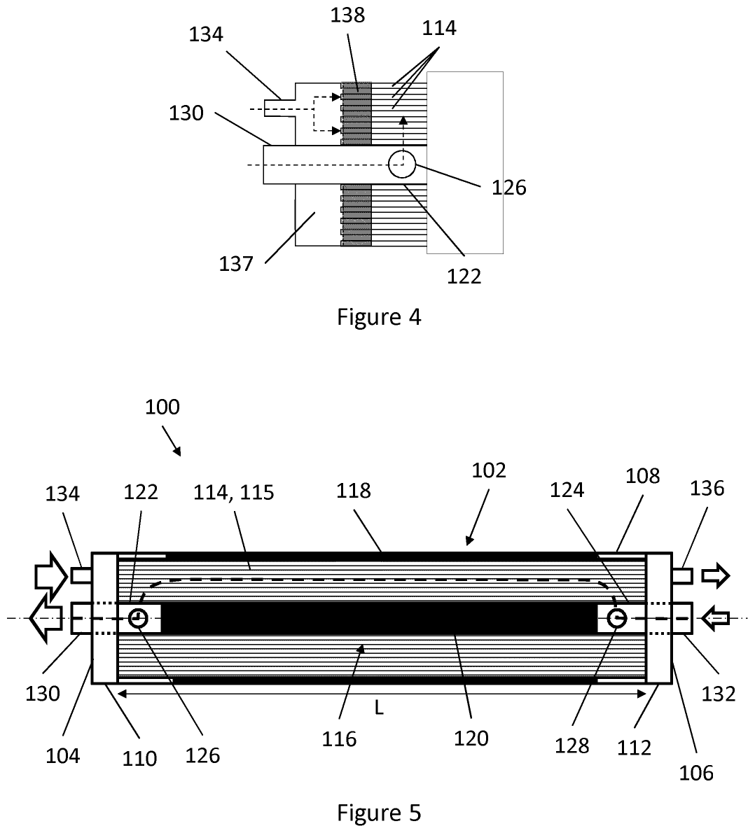

The pressure vessel 102 further comprises a first feed port 134 provided in the first end-face 104, and a second feed port 136 provided in the second end-face 106. The feed ports 134, 136 are each in fluid communication with the insides of the hollow fibre semipermeable membranes 114. As shown in FIG. 4, a gap between the end-face of the pressure vessel 102 and open ends of the hollow fibre semipermeable membranes 114 creates a manifold 137 where a feed stream can flow to/from the feed port and the hollow fibre semipermeable membranes 114. A sealing compound 138 prevents the feed stream entering the volume surrounding the outside of the hollow fibre semipermeable membranes 114.

In use in a pressure retarded osmosis system, either co-current or counter-current flow can be established as between the draw stream flowing around the outside of the hollow fibre semipermeable membranes 114 and the feed stream flowing inside the hollow fibre semipermeable membranes 114.

FIGS. 3a and 3b show arrows indicating co-current flow, where the first draw port 130 is used as a draw inlet, the first feed port 134 is used as a feed inlet, the second draw port 132 is used as a draw outlet, and the second feed port 136 is used as a feed outlet. FIG. 5 shows the osmosis module 100 according to the first embodiment of the disclosure, but with arrows indicating counter current flow. In this case, the first draw port 130 is used as a draw outlet, the first feed port 134 is used as a feed inlet, the second draw port 132 is used as a draw inlet, and the second feed port 136 is used as a feed outlet.

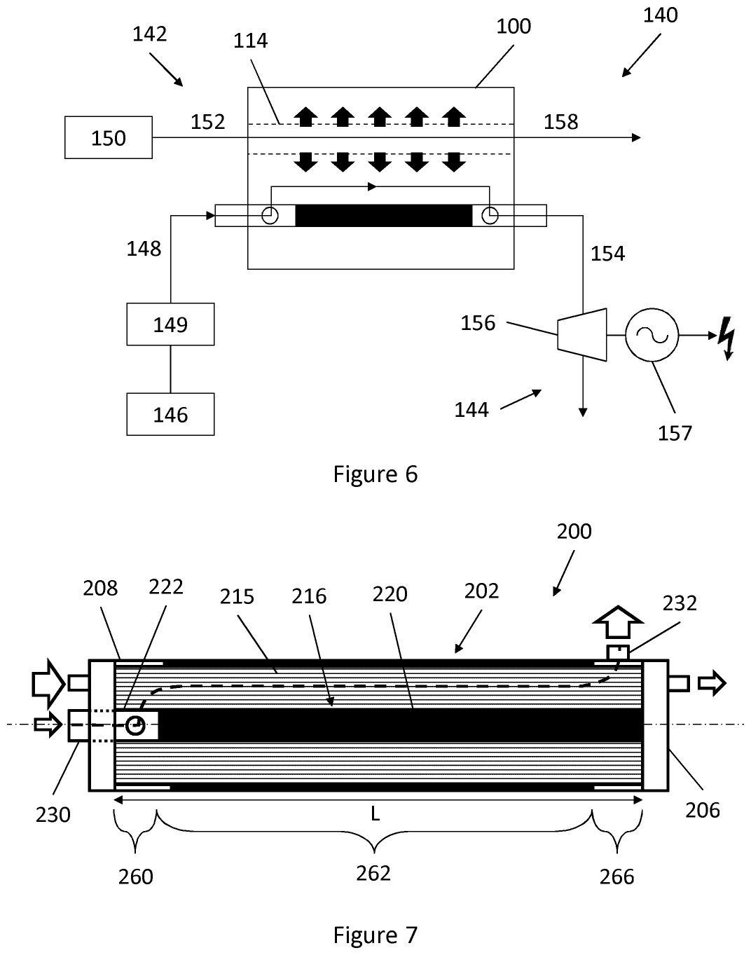

FIG. 6 shows a power generation system 140 comprising a pressure retarded osmosis system 142 and a power generation device 144. The pressure retarded osmosis system 142 comprises the osmosis module 100 according to the first embodiment of the disclosure in a co-current arrangement. The osmosis module 100 is shown schematically with a single hollow fibre semipermeable membrane 114.

A first reservoir 146 holds a saline solution from which is extracted a draw stream 148. The draw stream 148 is sent to a pump 149 to increase the pressure of the stream, and is then passed to the first draw port 130 (the draw inlet) of the osmosis module 100. A second reservoir 150 holds an aqueous solution, having a lower salt concentration than the saline solution, from which is extracted a feed stream 152. The feed stream 152 is passed into the first feed port 134 (the feed inlet) of the osmosis module 100.

The feed stream 152 is distributed amongst the hollow fibre semipermeable membranes 114 and flows through the inside of them to the second feed port 136 (the feed outlet). Simultaneously, the draw stream 152 follows a flow path through the pressure vessel to the second draw port 132 (the draw outlet). The flow path comprises a first portion in the first duct 122, a second portion in the annular fibre region 115, and a third portion in the second duct 124. When in the annular fibre region 115, the high concentration stream 148 flows around the outsides of the hollow fibre semipermeable membranes 114. Where the high concentration stream is forced to flow around the plug 120 in the central structure 116, the direction of flow is substantially parallel to the longitudinal axis of the central structure 116.

Due to the osmotic pressure difference between the draw stream 148 and the feed stream 152, water is transferred across the semipermeable membrane 114, even though the pressure on the draw stream 148 side is higher than on the feed stream 152 side. In FIG. 6, arrows show the direction of water transport by osmosis across the semipermeable membrane 114. The extra volume of fluid therefore leads to an increase in flow in the stream. A reduced concentration stream 154, derived from the draw stream 148, exits the osmosis module 100 via the second draw port 132. The reduced concentration stream 154 is sent to a turbine 156 of the power generation device 144, the turbine 156 turning the excess fluid pressure into kinetic energy. The turbine 156 drives a generator 157 thus producing electricity. An increased concentration stream 158, derived from the feed stream 152, exits the osmosis module 100 via the second feed port 136 and is disposed of. In embodiments, a pressure exchanger is used in place of, or in addition to, the pump 149 to pressurise the high concentration stream 148.

FIG. 7 shows an osmosis module 200 according to a second embodiment of the disclosure. The osmosis module 200 according to a second embodiment is similar to the osmosis module 100 according to the first embodiment, the osmosis module 200 according to a second embodiment differs in the position of the second draw port 232 and the configuration of the central structure 216.

In the osmosis module 200 according to a second embodiment, the second draw port 232 is provided in the surrounding wall 208 of the pressure vessel 202 at a location proximate the second end-face 206. The second draw port 232 is sufficiently close to the second end-face 206 that, in use, the draw stream flows along nearly the whole annular fiber region 215 before reaching the second draw port 232. In the embodiment shown, the second draw port 232 is provided less than 10% of the way along the length L of the annular fiber region 215 (measured in a direction from the second end of the pressure vessel). Furthermore, the plug 220 blocks the central structure 216 completely except for the portion which forms the first duct 222.

The flow path of the draw stream between the first draw port 230 and the second draw port 232 therefore comprises only a first portion provided by the first duct 222, and a second portion through the annular fibre region 215. An example flow along the flow path is shown as a dashed line.

A first lengthwise region 260 and a second lengthwise region 262 of the osmosis module 200 can be defined. The first region 260 extends along a first lengthwise portion of the annular fibre region 215. In the first region 260, the draw stream can flow between the first draw port 230 and the annular fibre region 215 via the central structure 216. The first region 260 is thus defined by, and extends along, the length of the first duct 222. The second region 262 extends along a second lengthwise portion of the annular fibre region 215. In the second region 260, the flow path of the draw stream is confined to the annular fibre region 215 and extends in a direction substantially parallel to the longitudinal axis of the pressure vessel 202.

In the osmosis module 200 a third region 266 can be defined which extends along a third lengthwise portion of the annular fibre region 115. In the third region 266, the draw stream can flow towards or away from the second draw port 232 in the surrounding wall 208. In the third region 266, the flow thus has a significant radial component and is no longer substantially parallel to the central structure 216.

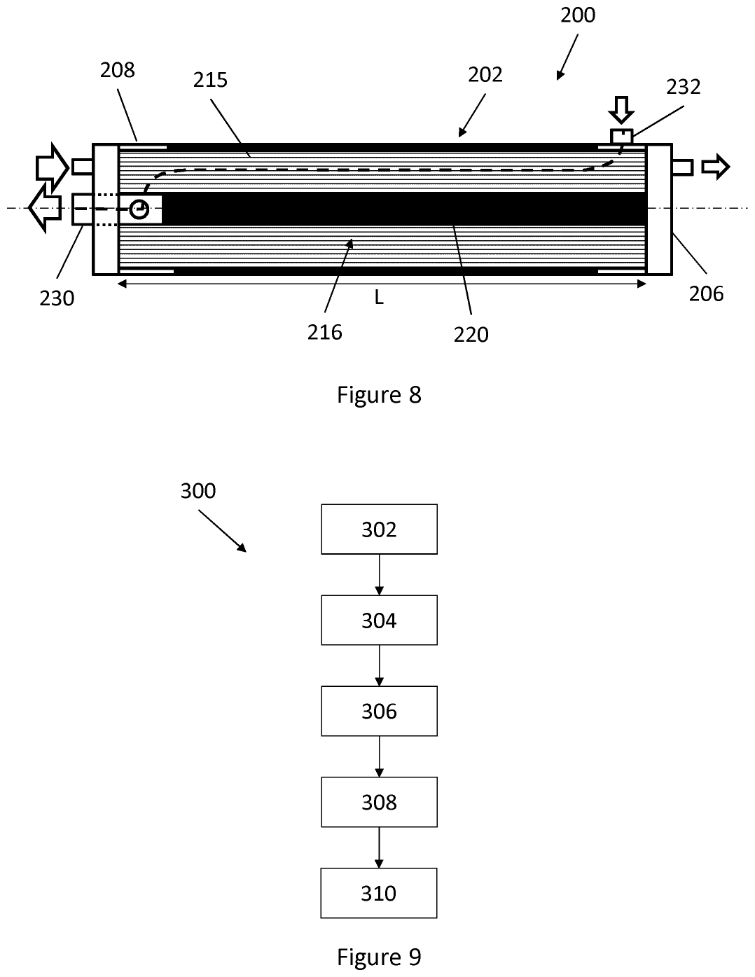

The osmosis module 200 can be used in either a co-current or counter-current arrangement. FIG. 7 shows arrows indicating co-current flow, and FIG. 8 shows the osmosis module 200 with arrows indicating counter current flow.

FIG. 9 shows a method 300 of modifying an osmosis module according to a third embodiment of the disclosure. The method 300 comprises, at step 302, providing an osmosis module.

In this embodiment, the osmosis module is similar to that shown in FIG. 2. The osmosis module comprises housing in the form of a pressure vessel. The pressure vessel comprises a first end-face, a second end-face, a surrounding wall extending between the first end-face and the second end-face, and a pair of draw ports for passage of a high concentration stream into and out of an interior of the pressure vessel, the pair of draw ports comprising a first draw port and a second draw port. The first draw port is provided in the first end-face, and the second draw port is provided in the surrounding wall proximate the second end-face.

A plurality of hollow fibre semipermeable membranes are received within the interior of the pressure vessel. The plurality of hollow fibre semipermeable membranes are provided around a central structure. The central structure is in the form of a duct structure. The duct structure comprises a pipe having a plurality of apertures distributed along the length of the pipe. The pipe is in fluid communication with the first draw port.

The plurality of hollow fibre semipermeable membranes are located within an annular fibre region which extends radially between the central structure and the surrounding wall of the pressure vessel. The annular fibre region has a length in a direction parallel to the longitudinal axis of the pressure vessel.

The method 300 comprises, at step 304, disassembling the osmosis module, including removing the plurality of hollow fibre semipermeable membranes and the central structure from the pressure vessel.

The method 300 comprises, at step 306, blocking the duct structure a part-way along its length by inserting a blocking member in the form of a plug into the pipe. The plug is dimensioned so as to block the majority of the pipe, leaving a section unblocked at one end. The unblocked section is that which, when inside the pressure vessel, is in fluid communication with the first draw port. The unblocked section forms a first duct having a length which means the first duct will extend only a part of the way along the length of the annular fibre region. No fluid can flow within the blocked section of the pipe.

The method 300 comprises, at step 308, wrapping the plurality of hollow fibre semipermeable membranes with a felt wrap. The wrap is passed around the circumference of the plurality of hollow fibre semipermeable membranes, leaving the ends uncovered.

The method 300 comprises, at step 310, reassembling the osmosis module by reinserting the plurality of hollow fibre semipermeable membranes and the central structure from the pressure vessel and closing the end-face with an end-cap.

The reassembled (modified) osmosis module is similar to that shown in FIG. 7. The osmosis module provides a flow path via which a draw stream can flow between the draw ports. A first portion of the flow path is through the unblocked section of the duct structure, i.e. the first duct, and a second portion of the flow path is through the annular fibre region. Due to the blocking of the duct structure, the duct structure provides the first portion of the flow path no further than a part of the way along the length of the annular fibre region. Furthermore, a first region and a second region of the osmosis module can be defined. The first region is defined by the lengthwise portion of the annular fibre region over which the central structure in unblocked. The second region is defined by the lengthwise portion of the annular fibre region over which the draw stream flow path is confined to the fibre region and extends substantially parallel to the central structure. The modifications may improve the energy efficiency of an osmosis process, for example a pressure retarded osmosis process, using the osmosis module. Additionally or alternatively, the method may allow existing commercially available units for lower pressure osmotic processes to be adapted for higher pressure PRO processes.

Whilst the present disclosure has been described and illustrated with reference to particular embodiments, it will be appreciated by those of ordinary skill in the art that the disclosure lends itself to many different variations not specifically illustrated herein.

For example, while the examples above show a single aperture in the first and/or third regions of the central structure more than one aperture may be provided in these regions. Similarly, while the plug 120 is centrally located along the central structure in FIG. 3a, the blockage of the central structure may be off centre in other embodiments. It is not essential for the central structure to be centrally located within the osmotic unit.

In some embodiments (not shown) a region of the surrounding wall 108 of the module may have a reduced inner diameter.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. An osmosis module for pressure retarded osmosis, the osmosis module comprising:
a pressure vessel comprising: a first end-face, a second end-face, a surrounding wall extending between the first end-face and the second end-face, and a pair of draw ports via which a draw stream can flow into and out of an interior of the pressure vessel, the pair of draw ports comprising a first draw port and a second draw port; and
a plurality of hollow fibre semipermeable membranes received within the interior of the pressure vessel and provided around a central structure, the plurality of hollow fibre semipermeable membranes being located within a fibre region which extends radially between the central structure and the surrounding wall and has a length in a direction parallel to the longitudinal axis of the pressure vessel;
wherein the first draw port is provided in the first end-face, and the central structure is in fluid communication with the first draw port;
wherein the osmosis module comprises a first region extending along a first lengthwise portion of the fibre region, and a second region extending along a second lengthwise portion of the fibre region;
wherein in the first region the draw stream can flow between the first draw port and the fibre region via the central structure;
wherein in the second region the flow path via which the draw stream flows between the draw ports is confined to the fibre region and extends substantially parallel to the central structure; and
wherein the second region extends along a majority of the length of the fibre region.

2. The osmosis module according to claim 1, wherein the second draw port is provided in the second end-face.

3. The osmosis module according to claim 2, wherein the central structure is in fluid communication with the second draw port, and
wherein the osmosis module comprises a third region extending along a third lengthwise portion of the fibre region, and in the third region the draw stream can flow between the second draw port and the fibre region via the central structure.

4. The osmosis module according to claim 1, wherein the first region extends along less than half the length of the annular fibre region.

5. The osmosis module according to claim 1, wherein the surrounding wall of the pressure vessel is free of ports for passage of fluid into and out of the interior of the pressure vessel.

6. The osmosis module according to claim 1, wherein the central structure comprises a duct structure, the duct structure being blocked part-way along its length so as to prevent fluid flow in the duct in the second region.

7. The osmosis module according to claim 1, wherein along a majority of the flow path in the fibre region, the net flow of the draw stream is in a direction parallel to the central structure.

8. The osmosis module according to claim 1, wherein the pressure vessel comprises: a first end cap providing the first end-face, and a second end cap providing the second end-face; the first end-cap and the second end-cap having substantially identical geometry.

9. The osmosis module according to claim 1, further comprising an exterior wrap or shell around the plurality of hollow fibre semipermeable membranes.

10. The osmosis module according to claim 1, wherein the fibre region is free of baffles within the second region.

11. The osmosis module according to claim 1, wherein the pressure vessel can withstand an operating pressure of at least 50 bar, optionally at least 100 bar, and optionally at least 200 bar.

12. The osmosis module according to claim 1, wherein the pressure vessel further comprises:
a pair of feed ports for passage of a feed stream into and out of the interior of the pressure vessel, the feed ports being in fluid communication with the interior of the hollow fibre semipermeable membranes

13. The osmosis module according to claim 12, wherein the pair of feed ports comprises a first feed port and a second feed port, the first feed port being provided in the first end-face and the second feed port being provided in the second end-face.

14. A pressure retarded osmosis system comprising:
an osmotic module according to claim 12;
wherein the pressure retarded osmosis system is configured to provide a draw stream to one of the draw ports, and a feed stream to one of the feed ports.

15. A pressure retarded osmosis system according to claim 14, wherein both the draw stream and the feed stream flow in a direction from the first end-face to the second end-face.

16. A pressure retarded osmosis system according to claim 14, wherein the draw stream flows in a direction from the first end-face to the second end-face, and the feed stream flows in a direction from the second end-face to the first end-face.

17. A power generation system comprising:
a pressure retarded osmosis system according to claim 14; and
a power generation device, for example a turbine.

18. A method of performing pressure retarded osmosis, the method comprising:
providing a pressure retarded osmosis system according to claim 14; and
passing a draw stream into said one of the draw ports, and a feed stream into said one of the feed ports.

19. A method of modifying an osmosis module, the osmosis module comprising:
a pressure vessel comprising: a first end-face, a second end-face, a surrounding wall extending between the first end-face and the second end-face, and a pair of draw ports via which a draw stream can flow into and out of an interior of the pressure vessel, the pair of draw ports comprising a first draw port and a second draw port; and
a plurality of hollow fibre semipermeable membranes received within the interior of the pressure vessel and provided around a central structure, the plurality of hollow fibre semipermeable membranes being located within a fibre region which extends radially between the central structure and the surrounding wall of the pressure vessel and has a length in a direction parallel to the longitudinal axis of the pressure vessel;
wherein the first draw port is provided in the first end-face, and the central structure comprises is in fluid communication with the first draw port;
wherein the method comprises a step of:
blocking the central structure part-way along its length such the osmosis module comprises:
a first region extending along a first lengthwise portion of the fibre region, wherein in the first region the draw stream can flow between the first draw port and the fibre region via the central structure, and
a second region extending along a second lengthwise portion of the fibre region, wherein in the second region the flow path, via which the draw stream flows between the draw ports, is confined to the fibre region and extends substantially parallel to the central structure; and
wherein the second region extends along a majority of the length of the fibre region.

20. The method according to claim 19, wherein the second draw port is provided in the second end-face, and the central structure is in fluid communication with the second draw port, and
the method comprises blocking a region of the central structure such that the first region is provided on one side of the blocked region, and a there is a third region of the osmosis module on another side of the blocked region;
wherein the third region extends along a third lengthwise portion of the fibre region, and in the third region the draw stream can flow between the second draw port and the fibre region via the central structure.

21. The method according to claim 19, further comprising a step of providing a wrap or shell around the plurality of hollow fibre semipermeable membranes so as to reduce flow of the draw stream along an inner surface of the surrounding wall.

22. (canceled)
